(19) United States
(12) Patent Application Publication
(10) Pub. No.: US 2011/0235146 A1
(43) Pub. Date: Sep. 29, 2011

(54) ELECTROWETTING OPTICAL ELEMENT ARRANGED FOR PREVENTING CHARGE ACCUMULATION, AND METHOD FOR MANUFACTURING AN ELECTROWETTING OPTICAL ELEMENT

(75) Inventors: Hermanus Feil, Valkenswaard (NL); Bente Adriaan Bordes, Waalre (NL)

(73) Assignee: MIORTECH HOLDING B.V., Eindhoven (NL)

(21) Appl. No.: 13/125,235

(22) PCT Filed: Oct. 16, 2008
(86) PCT No.: PCT/NL08/00228

§ 371 Date: Jun. 15, 2011

(51) Int. Cl. G02B 26/02; B05D 5/12

(52) U.S. Cl. 359/228; 427/126.4; 427/126.3

(57) ABSTRACT

An electrowetting optical element comprising a first electrode layer and a second electrode layer opposite said first electrode layer, and a containment space formed between said first and said second electrode layer. The first electrode layer comprises an insulating layer, and a hydrophobic surface layer contiguous to said containment space. The electrowetting element further comprises a barrier layer in between said insulating layer and said containment space, for preventing ion migration of ions from said containment space into said insulating layer, for preventing charge accumulation in said insulating layer. The disclosure further relates to a method of manufacturing an electrowetting element.

### FIELD OF THE INVENTION

The present invention relates generally to electrowetting elements, and in particular to an electrowetting optical element comprising a first electrode layer and a second electrode layer opposite said first electrode layer, and a containment space formed between said first and said second electrode layer, wherein said first electrode layer comprises an insulating layer, and a hydrophobic surface layer contiguous to said containment space.

The present invention further relates to a method of manufacturing an electrowetting optical element, said method comprising the steps of providing a first electrode layer and a second electrode layer opposite said first electrode layer, and providing a containment space formed between said first and said second electrode layer, further comprising a step of providing on said first electrode layer an insulating layer and a hydrophobic surface layer contiguous to said containment space.

### BACKGROUND OF THE INVENTION

Electrowetting technology is based on modification of an energy balance between on one hand surface tension forces of liquids and wetting properties of a solid surface, and on the other hand electrostatic forces induced by an applied voltage over a capacitor arrangement comprising said boundary layer.

An electrowetting element may subsequently from bottom to top be comprised of respectively a first electrode layer, an electrically insulating hydrophobic layer (i.e. having a hydrophobic boundary on a side opposite the side adjacent or nearest to the first electrode layer), a containment space comprising at least a polar liquid and a non-polar liquid immiscible with each other, and a second electrode in contact with at least the polar liquid. In practice, the liquids are contained in between for example pixel walls forming a containment tray and a top glass plate.

Various materials can be used for the electrically insulating hydrophobic layer, e.g. teflon™ (Polytetrafluoroethyline (PTFE)) is a suitable material having suitable optical and electrical properties. Materials which are to a large extend hydrophobic are considered preferable in the field of technology. As a non-polar liquid, one may use an oil such as decane. The selection criteria for selecting a suitable non-polar liquid include (apart from the liquid being non-polar), dielectric constant sufficiently large (the liquid is preferably a good isolator, or at least a poor conductor) and having an optical transmission coefficient that is suitable for the application wherein it is used (in practice the liquid will have low transmissibility, but in the present invention, a certain (small) degree of transmissibility may be advantageous, though not essential). Optical properties may be modified or adapted by introducing a small percentage of a dye in the non-polar liquid as an additive. The polar liquid preferably has good conductive properties, and should additionally be selected with respect to its optical properties. Preferably, the polar liquid is optically transmissive.

The principles of operation of an electrowetting element are as follows. In an unpowered state, i.e. when no voltage is applied over the first and second electrode, the lowest energetic state of the system is where the non-polar liquid forms a boundary layer between the polar liquid and the hydrophobic surface of the insulating layer. This is because the polar liquid is repelled by the hydrophobic layer. The poor transmissibility of the non-polar liquid then forms an obstruction to light that penetrates the system. When a voltage is applied over the electrodes, the lowest energetic state of the system becomes the situation wherein the (poorly conductive or insulating) non-polar liquid is pushed aside by the (conductive) polar liquid, and the polar liquid thereby being in direct contact with the insulating hydrophobic layer. Note that the voltage must be large enough for the electrostatic forces to overcome the repellent and surface tension forces that separate the polar liquid from the hydrophobic surface. In this situation, light that penetrates the system has rather unobstructed access to the insulating hydrophobic layer because of the well transmissibility of the polar liquid and the non-polar liquid being pushed aside.

International patent application number PCT/NL2007/000303 discloses the use of a separate hydrophobic surface layer comprised of a silane surface modification agent. This hydrophobic surface layer is not only hydrophobic, but comprises oilphilic properties as a result of its chemical composition and bonding of the agents silane group to the insulating layer. The oilphilic properties are provided by “oil”-groups, or groups having a similar chemical compositions as the non-polar liquid, present in the surface modification agent. These oilphilic properties are favourable to operational performance of the electrowetting element. In particular, it resolves the problem of non-closing pixels in conventional electrowetting elements.

A problem encountered with electrowetting elements in general, is that as a result of frequent powering up of the electrodes, charge accumulation occurs within the insulating layer of the electrowetting element. The charge accumulation overtime is the result of migration of charged ions from the water-salt solution of the electrowetting element into the insulating layer. As a result of charge accumulation in the insulating layer, the operational performance of the electro-wetting elements overtime deteriorates, until the non-polar liquid in the electrowetting element no longer responds to the on and off state of the electrodes.

### SUMMARY OF THE INVENTION

It is an object of the present invention to resolve the above-mentioned problem, and to provide an electrowetting element which is reliable, and of which the technical lifetime is extended compared to conventional electrowetting elements.

The above-mentioned object is achieved by the present invention in that there is provided an electrowetting optical element comprising a first electrode layer and a second electrode layer opposite said first electrode layer, and a containment space formed between said first and said second electrode layer, wherein at least one of said first or said second electrode layer comprises an insulating layer, and an interface between said insulating layer and said containment space, wherein said interface is arranged for preventing migration of ions from said containment space into said insulating layer, for preventing charge accumulation in said insulating layer.

The interface between the insulating layer and the containment space, according to the present invention, prevents migration of ions from the containment space into the insulating layer. This may be achieved in various ways. It is possible to modify the surface or boundary properties between the insulating layer and the containment space, such as to create a boundary, that prevents migration of ions. The present invention may also be implemented by means of a suitable choice of the insulating layer. A further option for implementing the present invention is to provide the insulating layer with a barrier layer or coating that prevents ion migration. According to an embodiment of the invention the interface is impermeable to ions.

It is noted here that the term ‘boundary’ is intended to mean in particular the plane indicating the limit or transition between the containment space and the (first or second) electrode layer. The term ‘surface’ is defined as the outer boundary of the (first or second) electrode layer or a material layer constituting or resembling the boundary. The term ‘interface’ may be defined as the surface forming a common boundary between the containment space and the electrode layer. In particular, both terms ‘interface’ and ‘surface’ present an entity that may, but does not necessarily, have a third dimension (thickness). A ‘boundary’ is by definition two-dimensional, therefore having no thickness.

Providing the interface comprising a barrier layer that prevents ion migration from the containment space to the insulating layer, prevents charge accumulation in the insulating layer. In particular, the barrier layer prevents migration of ions from the water-salt solution into the insulating layer. This may be achieved in various ways.

One preferred embodiment of the invention applies a barrier layer comprising a crystal structure, wherein the structure comprises a crystallographic defect level which is optimized for preventing migration of ions from the containment space into the insulating layer. The crystal structure, and in particular the amount of lattice defects therein, determines for a large part the ability of ions to penetrate via the barrier layer into the insulating layer. In particular migration of ions into the insulating layer can be prevented by minimizing the level of crystallographic defects in the crystal structure.

At the same time, it is important that the insulating layer has favourable optical properties, and enables transmission of light rays through the barrier layer. This may be achieved by both a suitable choice of materials, and a suitable thickness of the barrier layer. Dependent on material of the barrier layer, the transparency of this layer is improved by minimizing the thickness.

One preferred embodiment of the present invention applies a barrier layer which is deposited by means of atomic layer deposition. Atomic layer deposition enables to build up a very thin crystal structure, layer-by-layer, onto the insulating layer of the electrowetting element. This technique enables the forming of a solid state layer of material having a thickness of only one or a few atomic layers. The barrier layer may thereby be made very thin, which benefits the optical properties thereof. The neat and orderly lattice structure reduces the number of crystallographic lattice defects to a minimum, such that even while the barrier layer is very thin, preventing of ion migration through the layer is achieved.

According to an embodiment of the present invention, the barrier layer comprises at least one substance of a group comprising a metal oxide, such as titanium oxide, tantalum oxide, aluminium oxide, zirconium oxide, lanthanum oxide, hafnium oxide, hafnium scandium oxide, hafnium silicon oxide, silicon oxide, a metal nitride such as silicium nitride, tantalum nitride, titanium nitride, tungsten nitride, niobium nitride, molybdenum nitride, hafnium nitride, a metal oxynitride such as titanium oxynitride, tantalum oxynitride, aluminium oxynitride, zirconium oxynitride, lanthanum oxynitride, hafnium oxynitride, hafnium scandium oxynitride, hafnium silicon oxynitride, or a metal carbide such as tantalum carbide, titanium carbide, tungsten carbide, niobium carbide, molybdenum carbide, and hafnium carbide, and any combination of two, three, four or more thereof.

The barrier layer disclosed above may be combined with the insulating layer, such as to form an integrated barrier/insulating layer.

A hydrophobic surface layer may be a separate layer in between the containment space and the barrier layer, or may be an integral part of the barrier layer itself. In the latter case, the hydrophobic properties of the barrier layer are of course important. It is noted that aluminum oxide is known to have to some extend weak hydrophobic properties, and may therefore be just suitable for use as a barrier layer that at the same time forms the hydrophobic surface layer. In case the hydrophobic surface layer is a separate coating applied to the barrier layer, in between the barrier layer and the containment space, care should be taken that charge accumulation in the hydrophobic surface layer is prevented. Use of a (relatively thick) fluoro polymer layer is therefore discouraged, since despite the hydrophobic properties of the fluoro polymer layer, the problem of charge accumulation would be shifted to the hydrophobic surface layer.

A silane surface modification agent, such as an organosilane compound, may be applied as hydrophobic surface. In particular, and referring to the earlier mentioned International patent application PCT/NL2007/000303, a silane surface modification agent may provide the hydrophobic surface ‘oilphilic’ properties, improving operational performance of the electrowetting element. Using a silane surface modification agent has the additional benefit that a strong bonding can be achieved between the silane group of the silane surface modification agent molecules and Al₂O₃ molecules in the barrier layer. Therefore, if Al₂O₃ is the chosen material for the barrier layer, use of a silane surface modification agent as hydrophobic layer provides a preferred combination, given the synergy created by the strong bonding. Suitable silane surface modification agents that may be used with a variety of oils in the containment space may be elements of a group comprising dichlorodimethylsilane, decylsilane, or dodecyltrichlorosilane.

According to a second aspect of the present invention there is provided a method of manufacturing an electrowetting optical element in accordance with the first aspect described herein above.

### BRIEF DESCRIPTION OF THE DRAWINGS

The present invention will be further elucidated by means of the specific example with reference to the enclosed drawing, wherein:

FIG. 1 discloses an electrowetting element according to the present invention.

### DETAILED DESCRIPTION OF THE DRAWINGS

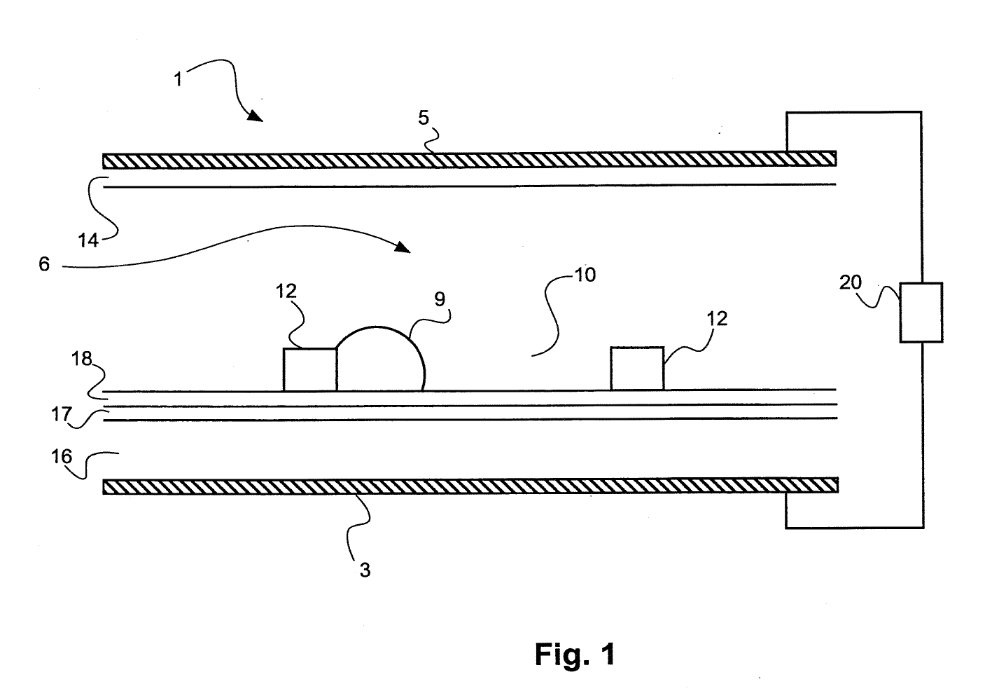

FIG. 1 discloses an electrowetting element, generally indicated with reference numeral 1. FIG. 1 is a schematic drawing, which illustrate only a part of the element comprising, in cross section, a pixel element of the electrowetting display element.

The electrowetting element comprises a first electrode layer 3, and a second electrode layer 5. In between the electrode layers 3 and 5, there is a containment space (generally indicated by reference numeral 6). The containment space is filled with a polar liquid, in the present case a water-salt solution, having a composition known to the skilled person. The pixels are formed by pixel walls 12 present within the containment space 6. Each pixel comprises a non-polar liquid, such as oily liquid 9.

The electrowetting element 1 of the invention, as illustrated in FIG. 1, is illustrated in the powered up state, wherein electrodes 3 and 5 are electrically powered and the polar liquid 10 forces the oily liquid 9 to one of the pixel walls 12 such as to lower the overall energy state of the system. In the unpowered state, the oily substance 9 spreads across the surface of the pixel covering the full pixel such that it becomes non transparent (or partly transparant depending on e.g. the optical properties of the oil). Operation of an electrowetting element is known to the skilled person, and not further discussed here.

Electrode layer 3 is covered with an insulating layer 16. Contiguous to the containment space 6, a hydrophobic coating 18 covers the barrier layer 17 of the electrowetting element of the present invention. Hydrophobic surface 18 may comprise any suitable hydrophobic material, but may in particular comprise a silane surface modification agent, having properties such that it is not only hydrophobic, but also minimizes the surface energy between the interface between layer 18 and the non-polar liquid 9. In particular, when using decane as non-polar liquid, use can be made of decylsilane, dichlorodimetylsilane, or dodecyltrichorosilane as silane surface modification agents. The hydrophobic surface thereby becomes oilphilic.

The barrier layer 17 may be comprised of aluminum oxide (Al₂O₃) deposited by means of atomic layer deposition onto insulating layer 16. It has been found that Al₂O₃ (ALD) has a dense crystal structure which is almost free of crystallographic defects. Because of this crystal structure, ions from the water-salt solution 10 in the containment layer are prevented to penetrate via the barrier layer into the insulating layer 16, and therefore charge accumulation over time in the insulating layer 16 is effectively prevented.

It is noted that the fact that the hydrophobic surface layer 18 comprises a silane surface modification agent is optional. Aluminium oxide (Al₂O₃) from itself has hydrophobic properties, and may therefore be suitable for use as a hydrophobic surface layer as well. The use of an additional hydrophobic surface layer however improves the operational performance of the electrowetting elements, as is described above. In addition, silane surface modification agents provide a strong bonding with the aluminum oxide barrier layer 17 of the present invention.

The term ‘electrode layer’ is to be interpreted broadly and comprises at least one electrode. The electrode layer, however, may also be embodied by a plurality of electrodes that may be operated independently. In general, the term ‘layer’ may be interpreted as comprising one or more physical layers linked by a common functional purpose or property. The term containment space may refer to a containment space associated with one or more independently or dependently operable pixels or sections of an electrowetting element. In the example of FIG. 1, the pixel walls 12 do not extend over the full height of the containment space, thereby the containment space 6 appears to be shared by multiple pixels that are operable independently. However, in a different embodiment, pixels may be physically separated from each other by pixels walls that do extend over the full height, such as to provide a containment space associated with each pixel.

Electrowetting elements of the kind described in this document, may be used in mirror arrangements such as to provide self-dimming vehicle mirrors. However, other fields of application of these kind of electrowetting elements may be display technology, optical switches, and so forth.

The present invention may be practised otherwise than as specifically described herein. In particular, the skilled person may use different components, such as different salt solution, various types of non-polar liquids, different kinds of polar liquids, different materials, etc. for providing an electrowetting element. The scope of the invention is only limited by the appended claims.

1. An electrowetting optical element comprising a first electrode layer and a second electrode layer opposite said first electrode layer, and a containment space formed between said first and said second electrode layer, wherein at least one of said first or said second electrode layer comprises an insulating layer, and an interface between said insulating layer and said containment space, wherein said interface is arranged for preventing migration of ions from said containment space into said insulating layer, for preventing charge accumulation in said insulating layer.

2. The electrowetting optical element according to claim 1, wherein said interface is impermeable to said ions.

3. The electrowetting element according to claim 1, wherein said interface comprises a boundary contiguous to said containment space, wherein said boundary is arranged for preventing said migration of said ions.

4. The electrowetting element according to claim 1, wherein said interface comprises a barrier layer for preventing said migration of said ions.

5. The electrowetting optical element according to claim 4, wherein said barrier layer is formed by a coating deposited by means of atomic layer deposition.

6. The electrowetting optical element according to claim 1, wherein said interface comprises a crystal structure, said crystal structure comprising crystallographic defect level optimized for preventing said migration of said ions.

7. The electrowetting optical element according to claim 6, wherein said crystallographic defect level is minimized.

8. The electrowetting optical element according to claim 1, wherein said interface comprises at least one substance of a group comprising a metal oxide, such as titanium oxide, tantalum oxide, aluminium oxide, zirconium oxide, lanthanum oxide, hafnium oxide, hafnium scandium oxide, hafnium silicon oxide, silicon oxide, a metal nitride such as silicium nitride, tantalum nitride, titanium nitride, tungsten nitride, niobium nitride, molybdenum nitride, hafnium nitride, a metal oxynitride such as titanium oxynitride, tantalum oxynitride, aluminium oxynitride, zirconium oxynitride, lanthanum oxynitride, hafnium oxynitride, hafnium scandium oxynitride, hafnium silicon oxynitride, or a metal carbide such as tantalum carbide, titanium carbide, tungsten carbide, niobium carbide, molybdenum carbide, and hafnium carbide, and any combination of two, three, four or more thereof.

9. The electrowetting element according to claim 1, wherein said interface further comprises a hydrophobic boundary contiguous to said containment space.

10. The electrowetting optical element according to claim 9, wherein said interface comprises a material layer comprising said hydrophobic boundary.

11. The electrowetting optical element according to claim 10, wherein said material layer comprises a silane surface modification agent selected from a group comprising decylsilane, dichlorodimethylsilane (DDMS), and dodecyltrichorosilane (DDTS, DDTCS).

12. A method of manufacturing an electrowetting optical element, said method comprising the steps of providing a first electrode layer and a second electrode layer opposite said first electrode layer, and providing a containment space formed between said first and said second electrode layer, further comprising a step of providing on said first electrode layer an insulating layer, and providing an interface between said insulating layer and said containment space, wherein said interface is arranged for preventing migration of ions from said containment space into said insulating layer, for preventing charge accumulation in said insulating layer.

13. The method according to claim 12, wherein said interface is provided comprising a barrier layer for preventing migration of ions from said containment space into said insulating layer during use of said electrowetting element, for preventing charge accumulation in said insulating layer.

14. The method according to claim 13, wherein said barrier layer is provided by means of atomic layer deposition.

15. The method according to claim 12, wherein for providing said interface, use is made of at least one substance of a group comprising a metal oxide, such as titanium oxide, tantalum oxide, aluminium oxide, zirconium oxide, lanthanum oxide, hafnium oxide, hafnium scandium oxide, hafnium silicon oxide, silicon oxide, a metal nitride such as silicium nitride, tantalum nitride, titanium nitride, tungsten nitride, niobium nitride, molybdenum nitride, hathnium nitride, a metal oxynitride such as titanium oxynitride, tantalum oxynitride, aluminium oxynitride, zirconium oxynitride, lanthanum oxynitride, hafnium oxynitride, hafnium scandium oxynitride, hafnium silicon oxynitride, or a metal carbide such as tantalum carbide, titanium carbide, tungsten carbide, niobium carbide, molybdenum carbide, and hafnium carbide, and any combination of two, three, four or more thereof.
